(19) United States
(12) Patent Application Publication
(10) Pub. No.: US 2009/0202885 A1
(43) Pub. Date: Aug. 13, 2009

(54) Process to prepare the self-stand electrode using porous supporter of electrode catalyst for fuel cell, a membrane electrode assembly comprising the same

(76) Inventors: Young Taek Kim, Seoul (KR); Min-ho Seo, Busan (KR); Byungchul Jang, Daejeon (KR); Dong Hwan Ryu, Cheong-ju (KR); Jung-Eun Yang, Daejeon (KR); Youngsu Jiong, Daejeon (KR)

Correspondence Address: CLARK & BRODY, 1090 VERMONT AVENUE, NW, SUITE 250, WASHINGTON, DC, 20005, US

(21) Appl. No.: 12/314,032

(22) Filed: Dec. 3, 2008

(30) Foreign Application Priority Data
Dec. 4, 2007 (KR) 10-2007-0125165

(51) Int. Cl. H01M 8/10; H01M 4/86; H01M 8/00

(52) U.S. Cl. 429/30; 429/40; 29/623.1

(57) ABSTRACT

The present invention relates to a porous electrode used in a polymer electrolyte membrane fuel cell, and more particularly to a method of preparing a membrane-electrode assembly by forming a self-stand electrode layer by coating catalyst ink on a non-conductive substrate having a macropore and then joining it to a polymer electrolyte membrane. The porous self-stand electrode according to the present invention allows moisture and gas to be smoothly discharged and inflowed in a high current density operation region to improve the performance of a fuel cell, and can be freely cutted to simplify the preparation process of the membrane-electrode assembly.

### TECHNICAL FIELD

The present invention relates to a porous electrode used in a polymer electrolyte membrane fuel cell, and more particularly to a method of preparing a membrane-electrode assembly by forming a self-stand electrode layer by coating catalyst ink on a non-conductive substrate having a macropore and then joining it to a polymer electrolyte membrane. The porous self-stand electrode according to the present invention allows moisture and gas to be smoothly discharged and inflowed in a high current density operation region to improve the performance of a fuel cell, and can be freely cutted to simplify the preparation process of the membrane-electrode assembly.

### BACKGROUND ART

A fuel cell is a device that directly converts chemical energy of fuel into electric energy by electrochemically reacting fuel such as hydrogen or methanol with oxygen, does not go through a carnot cycle differently from the existing thermal power generation, such that the fuel cell has high power generation efficiency, has little emission of pollutant such as NOx, SOx or the like, and does not generate noise during its operation, thereby having been spotlighted as a next clean energy source.

According to sorts of electrolyte used, the fuel cells is sorted as a polymer electrolyte membrane fuel cell (PEMFC), a phosphoric acid fuel cell (PAFC), a molten carbonate fuel cell (MCFC), a solid oxide fuel cell (SOFC) and the like. Among others, the polymer electrolyte membrane fuel cell has advantages of high power generation efficiency, low operation temperature and compactness over other fuel cells, such that it is highly expected to be used as a power source for automobile, a small-scale power generation device used in a house or the like, a mobile and emergency power source, a military power source or the like.

The polymer electrolyte membrane fuel cell commonly has a seven-layer structure of separator/gas diffusion electrode/fuel electrode/polymer electrolyte membrane/air electrode/gas diffusion electrode/separator. Among others, a five-layer structure excepting the separators on both sides thereof is commonly referred to as a membrane electrode assembly (MEA). Upon reviewing the operation principle of the fuel cell, fuel such as hydrogen, methanol or the like is supplied uniformly to the fuel electrode through a passage of the separator and the gas diffusion electrode, and air or oxygen is supplied uniformly to the air electrode through a passage of the separator and the gas diffusion electrode, in the same manner as the fuel electrode. In the fuel electrode, the fuel is oxidized to generate hydrogen ions and electrons, and at this time, the hydrogen ions move to the air electrode through an electrolyte membrane and the electrons move to the air electrode through a conductive wire and load constituting an external circuit. The hydrogen ions perform a reduction reaction with the electrons in the air electrode to generate water and the water is discharged to the external. Although there are various factors to affect the performance of the fuel cell, in the case of the membrane electrode assembly, a pore structure should be properly controlled so that gas diffusion, ion conductivity and moisture retention can be compatible in the fuel electrode and the air electrode. Thereby, it is very important to enlarge an active reaction area, which is commonly referred to as a 3-phase interface reaction area. In particular, a flooding phenomenon, which prevents inflow of the fuel gas as the water generating the electrode reaction in a high current density region is not discharged to remain in the electrode pore, interrupts the 3-phase interface from being formed in the electrode to cause deterioration of the performance of the fuel cell.

Therefore, there is a demand for developing a porous electrode for fuel cell for improving the performance of the fuel cell by maintaining the 3-phase interface by allowing the water and the fuel gas to be easily discharged and diffused even in the high current density operation region where a great quantity of water is generated by means of the electrode reaction.

Meanwhile, Korean Laid-Open Patent Publication No. 2005-0116581 discloses an electrode for fuel cell using a porous metal mesh thin film coated with carbon-based material as a substrate of the electrode. Korean Laid-Open Patent Publication No. 2006-0086531 discloses an electrode forming a penetration hole on a carbon paper and coating it with water-repellant polymer, and filling the penetration hole with hydrophilic polymer material in order to prevent the phenomenon, that the pore is clogged by means of water, by allowing the water formed in a cathode electrode to be easily discharged to the outside of the cell. However, when using the metal mesh, a problem arises in that durability is deteriorated due to corrosion of the metal, and when using the electrode including adsorption porous material in the penetration hole inside the electrode substrate, a disadvantage arises in that a manufacturing method thereof is complicated.

### DISCLOSURE OF THE INVENTION

It is an object of the present invention to provide a porous electrode for fuel cell, which introduces a macropore using a non-conductive porous substrate, and endows conductivity and electrochemical activity by coating catalyst ink having electrochemically excellent performance on the porous substrate to reduce a flooding phenomenon in a high current density operation region and to optimize a 3-phase interface, thereby making it possible to improve the performance of a fuel cell.

It is another object of the present invention to provide a porous electrode for fuel cell which can be independently manufactured, not depending on polymer electrolyte membrane or a gas diffusion layer and is thus easy in mass-production of the membrane-electrode assembly.

It is another object of the present invention to provide a membrane-electrode assembly prepared by joining the porous electrode for fuel cell to both sides of a polymer electrolyte membrane, and a fuel cell using the membrane-electrode assembly.

The present invention relates to a porous electrode for fuel cell, which introduces a macropore using a non-conductive porous substrate, and endows conductivity and electrochemical activity by coating catalyst ink having electrochemically excellent performance on the porous substrate, a membrane-electrode assembly prepared by joining the porous electrode to a polymer electrolyte membrane, and a method of preparing the same.

The porous electrode for fuel cell according to the present invention, which endows the conductivity and the electrochemical activity by coating the catalyst ink inside and on a surface of the non-conductive porous substrate, uses the non-conductive porous substrate to have no possibility to be deteriorated by corrosion compared to the case when a conductive substrate such as metal or the like, having an advantage that the deterioration in the characteristics of the fuel cell caused by long-term use is not generated. Also, since an organic polymer film is used as non-conductive porous substrate, processing such as a cutting is easily performed, having an advantage that it is easy in the mass-production of the membrane-electrode assembly.

The non-conductive porous substrate uses an organic polymer film having a thickness of 2 μm to 20 μm, more preferably, 5 μm to 15 μm, and porosity of 70% to 90%, more preferably, 80% to 90%. When the thickness of the organic polymer film is thinner than 2 μm, the pore of the organic polymer film may disappear at the time of compression, and when the thickness of the organic polymer film is thicker than 20 μm, resistance increases due to the increase of the electrode thickness to cause the reduction in the performance of the fuel cell. When the porosity is low, it is difficult to secure the pore which can easily discharge water, and when the porosity is high, the mechanical strength is low to cause a disadvantage that the pore disappears when the membrane-electrode assembly is prepared. An average pore size is 0.1 μm to 10 μm, more preferably, having a pore diameter of 0.5 μm to 2 μm. When the average pore size is less than 0.1 μm, a problem arises when water is discharged, and when the average pore size is more than 10 μm, a disadvantage arise in that inflowed water is discharged before it is diffused to a catalyst layer.

The polymer film, which is used as the non-conductive porous substrate, may be selected from polyethylene polymer, polypropylene polymer, polyisobutylene polymer, polyester polymer, polyurethane polymer, polyacrylic polymer, fluorine polymer, cellulosic polymer, or a mixture thereof, wherein a non-woven fabric type polymer film is more preferable since it has higher porosity and more excellent strength compared to a pore type where a pore is artificially formed.

In order to endow the conductivity and the electrochemical activity to the non-conductive porous substrate, the catalyst ink coated on the inside and surface of the conductive porous substrate has a viscosity of 100 to 300 cps and comprises catalyst particles with a mean secondary particle diameter (d50) of 2 μm or less, more preferably, in the range from 0.0001 μm to 2 μm.

When the viscosity of the catalyst ink is less than 100 cps, the amount of solvent increases to cause a problem that a flow or lump phenomenon may occur at the time of coating, and when the viscosity of the catalyst ink exceeds 300 cps, to have a problem in processing, so that it is preferable that the viscosity of the catalyst ink is controlled within the range as described above. Also, the catalyst particle has a catalyst component supported in a conductive carrier particle. More specifically, the catalyst particle is prepared from the process that the catalyst component selected from metal such as platinum, ruthenium, palladium, gold, iridium, rhenium, iron, nickel, cobalt, tungsten or molybdenum, or an alloy thereof, is supported in several nanometers on a surface of a conductive carrier particle selected from carbon-based material such as carbon black, activated carbon, carbon nanotube, carbon nanofiber, carbon nanohorn or carbonball, or a mixture thereof, wherein the supporting amount of the catalyst component is 10 to 60 parts by weight, based on 100 parts by weight of the carrier particle. Regarding the catalyst particle in the catalyst ink, it is good to have the smaller of the mean secondary particle diameter (d50), preferably, not exceeding 2 μm. This is the reason that when the mean secondary particle diameter (d50) of the catalyst particle exceeds 2 μm, a problem arises in that an active surface area decreases due to the macro particle, such that it is preferable to be dispersed using a homogenizer or a bead mill in order that the mean secondary particle diameter (d50) of the catalyst particle is less than 2 μm.

The content of the catalyst particle comprising in the catalyst ink is preferably 3 to 10 percent by weight to the total weight of catalyst ink. This is the reason that when the content of the catalyst particle is less than 3 percent by weight, the activity of the catalyst may be insignificant, and when the content of the catalyst particle is too high by exceeding 10 percent by weight, the dispersibility of the catalyst particle may be deteriorated.

Also, the catalyst ink of the present invention comprises 10 to 150 percent by weight of the ion conductive resin to the weight of the catalyst particle, and the solvent.

Also, Nafion ionomer (Dupont) may be exemplified as the ion conductive resin, wherein it is adsorbed to the surface of the catalyst particle to induce electrostatic repulsion or steric repulsion between particles, thereby partially serving to prevent the condensation between the particles. When the content of the ion conductive resin is less than 10 percent by weight to the weight of the catalyst particle, a problem arises in that the dispersibility of the catalyst particle may be deteriorated, and when the content of the ion conductive resin is too much by exceeding 150 percent weight, the activity of the catalyst particle may be deteriorated, such that it is preferable that the content of the ion conductive resin is controlled within the range described above.

The solvent may be selected from one or a mixture of two or more selected from water, alcohols, ketones or hydrocarbons. More specifically, the solvent may be selected from the group consisting of: water; alcohols such as methanol, ethanol, isopropyl alcohol, butanol, hexanol and Cyclohexanol; ketones such as acetone, methyl ethyl ketone (MEK), methyl isobutyl ketone (MIBK), cyclohexanone, isophorone and 4-hydroxy-4-methyl-2-pentanone; and hydrocarbons such as toluene, xylene, hexane, and cyclohexane; and a mixture thereof.

Also, except for the solvent described above, the catalyst ink according to the present invention more preferably comprises dispersible solvent selected from a group consisting of polyols, polyalkylene glycols, monoalkylethers of polyol and a mixture thereof. The dispersible solvent which is a solvent having relatively higher boiling point compared to the alcohol solvent, the ketone solvent or the hydrocarbon solvent. When a solvent selected from the alcohols, ketones or hydrocarbons is vapored during a catalyst ink coating process, in particular, during a spray coating process, to agglomerate catalyst particles and ion conductive resin, the dispersible solvent maintains the agglomerate for a predetermined time to change it to have a pore structure three-dimensionally suitable for entering raw material gas and discharging water, wherein the dispersible solvent does not chemically reacts with the catalyst particle and ion conductive resin and functions as a dispersant preventing the phase separation and agglomeration of the catalyst ink. More specifically, the dispersible solvent may use polyols such as ethylene glycol, propylene glycol, triethylene glycol, butylene glycol, 1,4-butanediol, 2,3-butanediol, glycerine or the like, polyalkylene glycols such as polyethylene glycol, polypropylene glycol or the like, or monoalkylether of polyol such as monomethyl ether or monoethylether of diethylene glycol or dipropylene glycol, or the like. When the content of the dispersible solvent is less than 0.01 percent by weight to the total weight of ink, the effect to suppress the agglomeration of the catalyst particle is insignificant, and when the content of the dispersible solvent is high by exceeding 3 percentage by weight, it has a high boiling point to have a disadvantage that a lump phenomenon may occur due to the solvent not dried after being coated. Therefore, the content of the dispersible solvent preferably has 0.01 to 3 percent by weight to the total weight of catalyst ink.

A method of coating the non-conductive porous substrate with the catalyst ink may use one or more methods selected from a spray coating method, an impregnation coating method, a gravure coating method, a slot die method, a comma coating method, and a lip coating method. The spray coating method, in which a catalyst layer can be infiltrated into a pore, is preferably used in order to endow conductivity to the non-conductive porous substrate.

FIG. 2 shows electron microscopes of a conductive porous substrate (a) before and (b) after being coated with catalyst ink, wherein the non-conductive porous substrate is endowed with conductivity and electrochemical activity, after being coated with catalyst ink, to function as an electrode of a fuel cell.

The present invention provides a method of preparing a membrane-electrode assembly for fuel cell including the following steps:
a) preparing a porous electrode by coating catalyst ink on a non-conductive porous substrate; and
b) joining the porous electrode to a polymer electrolyte membrane.

The step a) is a step to prepare the porous electrode, and the step b) is a step to prepare the membrane-electrode assembly by joining the prepared porous electrode to the polymer electrolyte membrane.

The polymer electrolyte membrane preferably forms of polymer which is excellent in view of proton-conductivity, electrochemical stability, and mechanical strength. As a representative example, all polymer resins having a cation-exchange group selected from the group consisting of sulfonic acid group, carboxylic acid group, phosphoric acid group, phosphonic acid group, and the derivatives thereof, in their side chains may be used. Preferably, one of perfluorosulfonic acid compound, doped polybenzimidazoles, polyetherketone and acid or base of polysulfone, or the combination of at least two may be used.

The porous electrode is joined to both sides of the polymer electrolyte membrane to form an anode electrode and a cathode electrode. The junction method of the polymer electrolyte membrane and the porous electrode is performed such that the polymer electrolyte membrane and the porous electrode are heated at a temperature higher by 10° C. to 20° C. compared to a glass transition temperature of polymer electrolyte without using a separate adhesive, and are compressed under a pressure of 60 to 120 kgf/cm².

Also, after the step b), the present invention may further comprise a step adding a gas diffusion layer to opposite surfaces to the anode and cathode electrodes. As the gas diffusion layer, a conductive carbon substrate is generally used. As the representative example, carbon paper, carbon fiber and carbon felt may be used.

A membrane-electrode assembly prepared according to the preparation method of the present invention includes a polymer electrolyte membrane; and a porous electrode layer joined to both sides of the polymer electrolyte membrane. The membrane-electrode assembly may further include a gas diffusion layer added to the external side of the porous electrode layer. One example of the membrane-electrode assembly according to the present invention is shown in FIG. 1. As shown in FIG. 1, the membrane-electrode assembly according to the present invention has a structure in which an anode electrode and a cathode electrode are included in the positions opposite to each other having the polymer electrolyte membrane therebetween, and a gas diffusion layer is added to the opposite surfaces to the anode and cathode electrodes.

Referring to FIG. 1, the membrane-electrode assembly according to the present invention has a macropore 103 by means of a non-conductive porous substrate, a micropore 102 by means of an electrode catalyst, and a macropore 101 by means of the gas diffusion layer. The macropore in the catalyst layer serves to smoothly inflow and discharge moisture, and the micropore in the catalyst layer serves to diffuse fuel gas inflowed into the catalyst layer. The pore in the gas diffusion layer functions as a passage to inflow and discharge water and gas. Therefore, with the structural characteristics as described above, as shown in FIG. 3, the membrane-electrode assembly according to the present invention allows water and fuel gas to be smoothly discharged and diffused in a high current density operation region having a large quantity of water due to the electrode reaction, improving the performance of the fuel cell.

Therefore, the present invention provides the polymer electrolyte fuel cell having the excellent performance including the membrane-electrode assembly prepared according to the preparation method as described above.

As described above, the porous electrode for fuel cell according to the present invention reduces the flooding phenomenon in the high current density operation region, improves the performance of the fuel cell by enlarging a 3-phase interface, and is able to be prepared independently not depending on the polymer electrolyte membrane or the gas diffusion layer, making it possible to be easily mass-produced.

### BRIEF DESCRIPTION OF THE DRAWINGS

FIG. 1 is a schematic diagram of a membrane-electrode assembly according to the present invention;

FIG. 2 shows photos that a surface of the electrode prepared according to the embodiments of the present invention is observed using a scanning electron microscope, photo (a) before being coated with catalyst ink and photo (b) after being coated with catalyst ink; and

FIG. 3 is a graph showing current-voltage characteristics of membrane-electrode assemblies each prepared by examples 1 to 4 and comparative example.

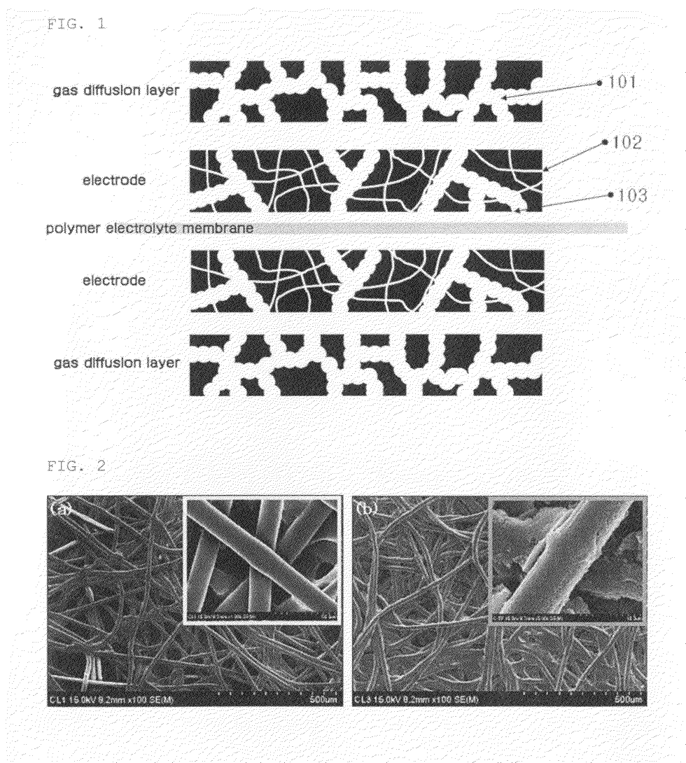

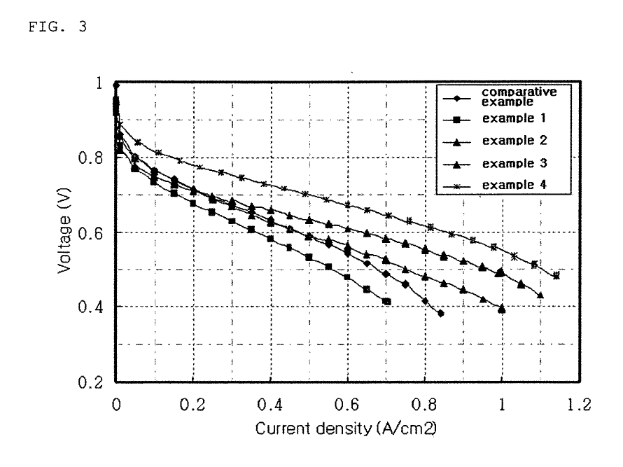

### BEST MODE FOR CARRYING OUT THE INVENTION

Hereinbelow, the present invention will be described in detail with reference to Examples. The present invention may, however, be embodied in many different forms and should not be construed as being limited to the Examples set forth herein.

### Example 1

### (1) Preparation of Catalyst Ink

40 wt % Pt/C (Tanaka Kikinzoku Kogyo Kabushiki Kaisha)/water/isopropyl alcohol/ionomer (20% Nafion solution) are mixed at a mixing ratio 1:6:6:6 wt %/wt % shown in the publicly known document (J. H. Kim et al, J. Power Sources 135 (2004) 29.) and then put into a bath maintained at 4° C., thereby being stirred at 10,000 RPM using a homogenizer for two hours. The prepared catalyst ink is ripen for twenty-four hours and is sonificated for ten minutes before it is to be coated, thereby being used. The viscosity of the prepared catalyst ink is 200 cps and the d50 value of a secondary diameter of the catalyst particle is 0.65 μm.

### (2) Coating of Catalyst Ink

A non-conductive porous substrate (mixture of viscose rayon/polyester (DuPont Company, Name of Product: Sontara), 85% porosity, average pore size 4 μm) having a thickness of 20 μm is put on a spray coating device of whose lower plate is heated at 70° C. and its both sides are coated with the prepared catalyst ink. At the time of coating, the catalyst supported is set to 0.2 mg/cm². In order to remove solvent after being coated, the non-conductive porous substrate is heated in the oven at a temperature of 100° C. for three minutes, and then is cut to have an electrode active area of 25 cm².

### (3) Preparation of Membrane-Electrode Assembly

Prepared electrodes (anode electrode and cathode electrode) are joined to an electrolyte membrane (Nafion NRE212) using a heat compression (130° C., three minutes).

### (4) Engagement of Unit Cell

It is engaged in the sequence of end plate/mono-polar plate/gasket/gas diffusion layer/membrane-electrode assembly/gas diffusion layer/gasket/mono-polar plate/end plate. Engagement torque to be engaged is fixed at 100 kgf.cm. The prepared unit cell is connected to a gas supplier, a humidifier, a heater, and an electronic load (pro-digit company) and then goes through an activation step using a constant voltage circulation method (IV to 4V, step 0.05V), while supplying hydrogen and air of 0.5 SLM and 1.6 SLM, respectively. After the activation step is completed, current-voltage characteristics are measured, while maintaining the equivalence ratio of hydrogen and air at 1.2:2.

### Example 2

A membrane-electrode assembly is prepared in the same manner as that shown in the example 1 and then a unit cell is engaged. However, a porous substrate having a thickness of 5 μm is used.

### Example 3

A membrane-electrode assembly is prepared in the same manner as that shown in the example 1 and then a unit cell is engaged. However, a porous substrate having a thickness of 10 μm is used.

### Example 4

5.3 g of platinum catalyst supported in carbon particles is mixed with 25 g of water and then the mixture thereof is stirred in a stirred vessel to form solution A. Separate therefrom, 21 g of isopropyl alcohol as solvent having a low boiling point is mixed with 31.6 g of ion conductive resin solution of 5 wt % Nafion and the mixture thereof is stirred to form solution B. The solution B is input to the stirring solution A and then is dispersed for an hour using a sealed homogenizer. Thereafter, solution C mixed with 6.6 g of water and 10.6 g of ethylene glycol as dispersible solvent is stirred for ten hours to prepare a catalyst slurry. The prepared catalyst slurry is ripen below a temperature of 5° C. for twenty-four hours to remove coarse particles using a polymer membrane filter having a size of 5 μm, finally obtaining catalyst ink having viscosity value of 230 cps. The mean size of the secondary particle of the catalyst dispersed in ink is 0.4 μm.

Excepting the method for preparing the catalyst ink, a membrane-electrode assembly is prepared in the same manner as that shown in the example 1 and then a unit cell is engaged. However, a porous substrate having a thickness of 10 μm is used.

### Comparative Example

The catalyst ink prepared in the same manner as that shown in the example 1 is coated on Nafion NRE212 to have a valid area of 25 cm² using the same spray coating device as that shown in the example 1. At the time of coating, the catalyst supported is set to 0.2 mg/cm². A unit cell is engaged using a prepared MEA by means of the same manner as that shown in the example 1 and then current-voltage characteristics are evaluated.

FIG. 3 shows current-voltage characteristics of MEAs manufactured by means of examples 1, 2, 3 and 4 and a comparative example. Each MEA shows the current-voltage characteristics of cases where the thickness of porous substrates is changed (Example 1: 20 μm, Example 2: 5 μm, and Example 3: 10 μm) and dispersible solvent is used (Example 4, and the thickness of porous substrate: 10 μm), and the comparative example where the porous substrate is not used. In the cases of the example 2 and the comparative example, although they show the similar function, owing to the effects of the porous substrate, the example 2 shows the improved performance in the high current section (60 mA/cm² or more) affected by the transfer of material (discharge of raw material gas and water) compared to the comparative example. In the case of the example 1, as the non-conductive porous substrate becomes thick, the resistance to the electrode increases to decrease the performance. When the porous substrate having a thickness of 10 μm is used, the pore is maintained at the time of compression, making it possible to obtain the performance improved by 20% (based on 0.6V current density) compared to the comparative example. Also, the example 4 having the composition of ink controlling micropore of the electrode shows the performance improved by 60% (based on 0.6V current density) compared to the comparative example.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A porous electrode for fuel cell, which is prepared by coating catalyst ink on the inside and surface of a non-conductive porous substrate formed of an organic polymer film, wherein the catalyst ink has a viscosity of 100 to 300 cps and comprises catalyst particles with a mean secondary particle diameter (d50) of 2 μm or less, and the organic polymer film has a thickness of 2 to 20 μm and a porosity of 70 to 90%.

2. The porous electrode for fuel cell as set forth in claim 1, wherein the catalyst ink comprises 3 to 10 percent by weight of catalyst particles to the total weight of the catalyst ink, 10 to 150 percent by weight of ion conductive resin to the weight of the catalyst particles, and solvent.

3. The porous electrode for fuel cell as set forth in claim 2, wherein the solvent is selected from the group consisting of water, alcohols, ketones, hydrocarbons and a mixture thereof.

4. The porous electrode for fuel cell as set forth in claim 3, wherein the catalyst ink further comprises dispersible solvent selected from the group consisting of polyols, polyalkylene glycols, monoalkylethers of polyol and a mixture thereof by 0.01 to 3 percent by weight to the total weight of the catalyst ink.

5. The porous electrode for fuel cell as set forth in claim 1, wherein the non-conductive porous substrate is a non-woven fabric type, being formed of polyethylene polymer, polypropylene polymer, polyisobutylene polymer, polyester polymer, polyurethane polymer, polyacrylic polymer, fluorine polymer, cellulosic polymer, or a mixture thereof.

6. A method of preparing a membrane-electrode assembly for fuel cell, comprising the steps of:
a) preparing a porous electrode by coating catalyst ink on a non-conductive porous substrate; and
b) joining the porous electrode to a polymer electrolyte membrane.

7. The method of preparing the membrane-electrode assembly for fuel cell as set forth in claim 6, wherein the catalyst ink has a viscosity of 100 to 300 cps and comprises catalyst particles with a mean secondary particle diameter (d50) of 2 μm or less.

8. The method of preparing the membrane-electrode assembly for fuel cell as set forth in claim 7, wherein the catalyst ink comprises 3 to 10 percent by weight of catalyst particles to the total weight of the catalyst ink, 10 to 150 percent by weight of ion conductive resin to the weight of the catalyst particles, and solvent.

9. The method of preparing the membrane-electrode assembly for fuel cell as set forth in claim 8, wherein the solvent is selected from the group consisting of water, alcohols, ketones, hydrocarbons and a mixture thereof.

10. The method of preparing the membrane-electrode assembly for fuel cell as set forth in claim 8, wherein the catalyst ink further comprises a dispersible solvent selected from the group consisting of polyols, polyalkylene glycols, monoalkylethers of polyol and a mixture thereof by 0.01 to 3 percent by weight to the total weight of the catalyst ink.

11. The method of preparing the membrane-electrode assembly for fuel cell as set forth in claim 6, wherein the catalyst ink is dispersed with a homogenizer or a bead mill before being coated.

12. The method of preparing the membrane-electrode assembly for fuel cell as set forth in claim 6, wherein the coating in the step a) is made by one or more methods selected from a spray coating method, an impregnation coating method, a gravure coating method, a slot die method, a comma coating method, and a lip coating method.

13. The method of preparing the membrane-electrode assembly for fuel cell as set forth in claim 6, wherein the non-conductive porous substrate is an organic polymer film having a thickness of 2 to 20 μm and a porosity of 70 to 90%.

14. The method of preparing the membrane-electrode assembly for fuel cell as set forth in claim 13, wherein the non-conductive porous substrate is a non-woven fabric type.

15. The method of preparing the membrane-electrode assembly for fuel cell as set forth in claim 14, wherein the non-conductive porous substrate is formed of polyethylene polymer, polypropylene polymer, polyisobutylene polymer, polyester polymer, polyurethane polymer, polyacrylic polymer, fluorine polymer, cellulosic polymer, or a mixture thereof.

16. A membrane-electrode assembly, comprising:
a polymer electrolyte membrane; and
a porous electrode layer formed by joining a porous electrode for fuel cell in claim 1 to both sides of the polymer electrolyte membrane.

17. A fuel cell including the membrane-electrode assembly of claim 16.
